(19) United States
(12) Patent Application Publication
(10) Pub. No.: US 2004/0028864 A1
(43) Pub. Date: Feb. 12, 2004

(54) In-pack inserts

(76) Inventor: Donavon D. Nelson, Woodbury, MN (US)

Correspondence Address: THE LAW OFFICES OF WILLIAM W. COCHRAN, LLC, 3555 STANFORD ROAD, SUITE 230, FORT COLLINS, CO, 80525, US

(21) Appl. No.: 10/457,063

(22) Filed: Jun. 6, 2003

Related U.S. Application Data
(60) Provisional application No. 60/387,230, filed on Jun. 6, 2002.

(51) Int. Cl. B32B 9/00

(52) U.S. Cl. 428/40.1

(57) ABSTRACT

Disclosed is an in-pack insert that is applied to a package using an adhesive backed liner. The in-pack insert is placed inside of a package and viewable through a window or other mechanism of the package. The insert may be a collectable item such as a collector card and may have various mechanisms whereby a consumer may remove the insert without damaging the insert. The in-pack insert may be assembled using high-speed automated equipment and applied to the packages at high speeds. Various embodiments of the insert are disclosed along with methods of manufacture and application.

### CROSS REFERENCE TO RELATED APPLICATIONS

The present application is based upon and claims the benefit of U.S. Provisional Patent Application Serial No. 60/387,230 by Donavon D. Nelson, entitled “In-Pack Inserts” filed Jun. 6, 2002, the entire contents of which is hereby specifically incorporated by reference for all it discloses and teaches.

### BACKGROUND OF THE INVENTION

a. Field of the Invention

The present invention pertains generally to packaging and more specifically to in-pack inserts for packaging.

b. Description of the Background

Packaging for consumer products is an important vehicle for promoting a product and affecting a consumer's decision to purchase one product over another. The more eye-catching a package is, the more likely a consumer will consider purchasing the product and thus sales may be increased.

Promotions and special offers, such as premiums, coupons, and other articles may be attached to the packaging to encourage the purchase of the product. Premiums that are mounted on the outside of the package are prone to damage and pilferage. In some cases, instructional booklets or other items necessary for the proper operation or function of the product may be attached to the packaging.

Some promoters have placed premiums inside the packaging and have used graphics on the outside of the package to indicate the presence of the premium and describe the premium. Other promoters have displayed a portion of the premium through a window or hole in the packaging. In general, these promoters have used a hot melt glue to attach the premium to the inside of the packaging. The hot melt glue has several manufacturing and functioning difficulties. For example, during the period when the hot glue is cooling, the premium may move. Other problems are that the glue may sometimes be messy to handle and cause blemishes on the insert or the package.

The speed of the hot glue process is limited. The maximum rate possible may be on the order of 10,000 parts per hour. The speed limitation adds to the cost of the assembled package and may be a limiting factor in the ability for a supplier to respond to an order.

It would therefore be advantageous to provide a device and method of adding an in-pack article that is cost effective and high speed. It would be further advantageous for the device and method to accommodate various forms of inserts and items and various methods of enabling a consumer to retrieve the premium from the packaging.

### SUMMARY OF THE INVENTION

The present invention overcomes the disadvantages and limitations of the prior art by providing an in-pack insert that may be manufactured and applied at high speeds. The speed of the application process is much higher than the prior art with improved registration and cleanliness. Further, the present invention affords the promoter a wide latitude of options for the inclusion of premiums into packages, and different methods for the consumer to retrieve a premium from the package.

The present invention may therefore comprise a method for assembling an in-pack insert to the inside of a package, the package having an inside surface, and outside surface, and a window formed therein for viewing the insert from the outside of the package comprising: providing an insert that is substantially planar and having a viewable side and a back side; placing the viewable side of the insert against the inside surface of the package such that at least a portion of the insert is viewable through the window; providing a film having an adhesive side, the adhesive side having adhesive covering at least a portion of the adhesive side; and placing the film onto the inside surface of the package such that at least a portion of the adhesive side of the film is adhered to the inside surface of the package and at least a portion of the adhesive side of the film is against the back side of the insert to hold the insert in placed on the inside surface of the package aligned with the window so that the viewable side of the insert is visible through the window on the outside of the package.

The present invention may further comprise a method for manufacturing an in-pack insert comprising: providing a carrier web having a release surface; placing an insert onto the carrier web such that a viewable portion of the insert is placed against the release surface of the carrier web; placing an adhesive backed liner over at least a portion of the insert such that an adhesive backed side of the adhesive backed liner is placed against the release surface of the carrier web; and presenting the carrier web such that the adhesive backed liner may be peeled from the carrier web and placed over a window in a package such that at least a portion of the viewable surface of the insert is viewable through a window of the package when viewed from an external surface of the package.

The present invention may further comprise a package with an in-pack insert comprising: a package having a window, an outside surface, and an inside surface, the outside surface being a viewable surface when the package is assembled; an insert being substantially planar and having a viewable side and a back side, the viewable side of the insert being placed against the inside surface of the package such that at least a portion of the insert is viewable through the window; a film having an adhesive side, the adhesive side having adhesive covering at least a portion of the adhesive side, the film being placed onto the inside surface of the package such that at least a portion of the adhesive side of the film is against the inside surface of the package and at least a portion of the adhesive side of the film is against the back side of the insert.

The present invention may further comprise an in-pack insert comprising: a carrier web having a release surface; an insert placed onto the carrier web such that a viewable portion of the insert is placed against the release surface of the carrier web; an adhesive backed liner placed over at least a portion of the insert such that an adhesive backed side of the adhesive backed liner is placed against the release surface of the carrier web, such that the adhesive backed liner may be peeled from the carrier web and placed over a window in a package such that at least a portion of the viewable surface of the insert is viewable through the window of the package when viewed from an external surface of the package.

The present invention may further comprise an in-pack insert comprising: a first means for visually enhancing a package; a second means for releasably carrying and presenting the first means; and a third means for entrapping the first means to an inside surface of the package such that the second means is viewable through a window in the package.

The advantages of the present invention are that in-pack inserts may be manufactured and applied at very high speeds. Further, the inserts may be applied without the manufacturing difficulties and mess of the prior art. The various embodiments of the present invention afford the promoter a large range of options for including items into in pack inserts.

### BRIEF DESCRIPTION OF THE DRAWINGS

In the drawings,

FIG. 1 is an illustration of an embodiment of the present invention showing a box that has a window through which a premium is visible.

FIG. 2 is an illustration of an embodiment of the present invention showing a fan-folded liner having many in-pack items attached.

FIG. 3 is an illustration of an embodiment of the present invention showing an in-pack item being placed on an unfolded carton.

FIG. 4 is an illustration of an embodiment of the present invention showing a collectable sports card applied as an in-pack premium.

FIG. 5 is a cross sectional view of embodiment of FIG. 4.

FIG. 6 is an illustration of an embodiment of the present invention showing an embroidered patch captured between a face sheet and an optional interior release sheet.

FIG. 7 is a cross sectional view of the embodiment of FIG. 6.

FIG. 8 is an illustration of an embodiment of the present invention showing a zip out release mechanism that allows a consumer to easily remove a premium from a package insert.

FIG. 9 is a cross sectional view of the embodiment of FIG. 8.

FIG. 10 is an illustration of a first embodiment of the present invention showing a method of producing an in-pack insert.

FIG. 11 is an illustration of an embodiment of the present invention showing a second method of producing an in-pack insert.

### DETAILED DESCRIPTION OF THE INVENTION

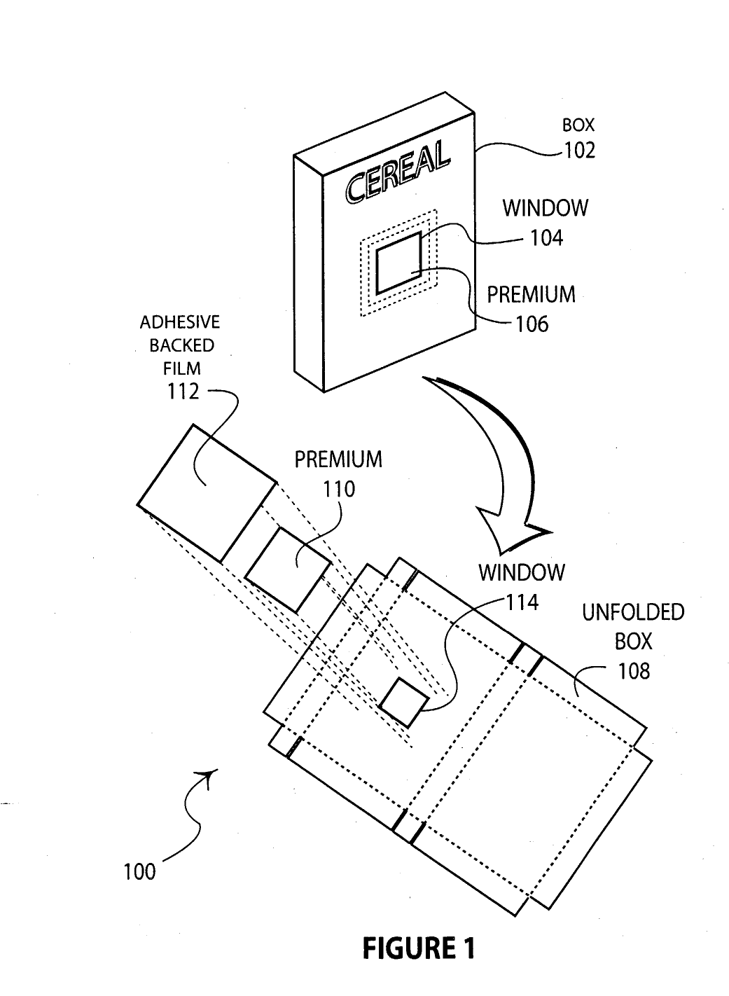

FIG. 1 illustrates an embodiment 100 of the present invention showing a box 102 that has a window cut out 104 through which a premium 106 is visible. The unfolded box 108 has a window 110. A premium 112 is assembled to the unfolded box 108 by an adhesive backed film 114.

The embodiment 100 securely holds an in-pack item, such as premium 106, in a manner that is visible from the exterior of the package. The premium 106 is secured such that it is unlikely to be damaged or pilfered and thusly enhances the consumer appeal of the product.

The premium 106 may be many different types of articles. The premium 106 may be a permanently attached advertising related item, a removable redemption item, a removable premium, an instructional booklet, an item to be incorporated into the use of the main product, or any other item as may be envisioned.

For example, the premium 106 may be a lenticular or holographic image. In other cases, the premium 106 may be foil printed or have other bright, eye catching features. Such features may be very expensive to produce on an entire box or carton and thus the premium 106 may be a lower cost way to produce a box with an eye catching feature. The use of a specialized advertising in-pack insert may be done for a short promotional period, or as a standard feature of a package for a particular product.

In another example, the premium 106 may be a removable redemption item. The premium 106 may be a coupon, game piece, credit card, or other item. Such items may be removable by the consumer only after the purchase of the package. Such items may include phone cards, redemption cards for purchases at a particular store, a computer disk with software, and other such devices. The premium 106 may be a printed paper label or may be a printed and embossed plastic card.

In another example, the premium 106 may be a removable premium. The premium 106 may be a collectable sports card, a woven patch, a metal token, a plastic toy, a music CD, or any other premium as may be desired.

In yet another example, the premium 106 may be an item that is incorporated into the operation of the main product. For example, the premium 106 may be hardware such as screws and nuts that are used to assemble the product inside the packaging. In other examples, the premium 106 may be a packet of lemon juice for incorporation into a liquid beverage, a packet of lubricant for a hardware item, or any other item as may be envisioned.

The adhesive backed film 112 may permanently mount the premium 110 into the package 108. In such cases, adhesive may completely cover the surface of the film that bonds to the premium 110 and package 108. The film 112 may be transparent or opaque and may be selected for strength and durability.

The adhesive backed film 112 may mount the premium 110 to facilitate the removal of the premium 110 from the inside of the package 108. In such embodiments, adhesive backed film 112 may have adhesive selectively placed on specific portions of the film. In some cases, perforations or other mechanical release mechanisms may be incorporated into the adhesive backed film 112.

The package 108 may be constructed of paperboard, cardboard, or other fiber based product. In some cases, the package 108 may be a plastic product such as plastic film or sheet. In still other cases, the package 108 may be a laminate of plastic and fiber based products. In the cases where the package material may be transparent, the window 114 may be produced by selectively not printing over the area. In cases where the package material is opaque, the window 114 may be produced by cutting a hole in the packaging.

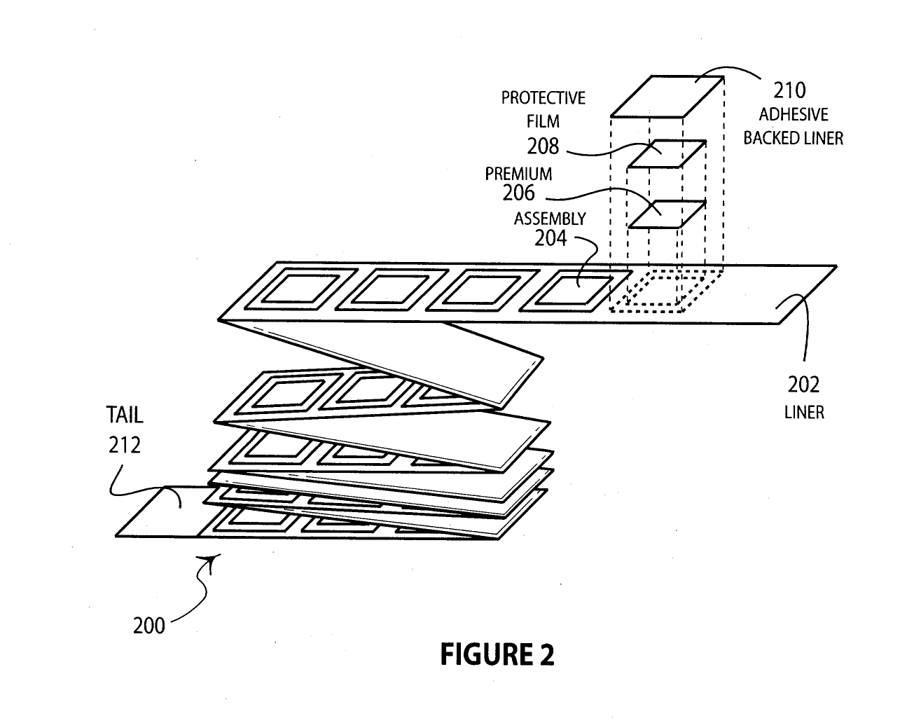

FIG. 2 illustrates an embodiment 200 of the present invention showing a fan-folded liner 202 that has many in-pack items 204 attached. The in-pack items may comprise a premium 206, a protective film 208, and an adhesive backed film 210. Other configurations of the in-pack items 204 will be discussed hereinafter.

The embodiment 200 is a configuration for the presentation and placement of in-pack items 204 that is readily adapted to conventional label placement machines. The fan-folded liner 202 allows the tail 212 to be attached to another fan-folded liner for continuous feed into automated placement machines. In other configurations, the liner 202 may be presented on a roll.

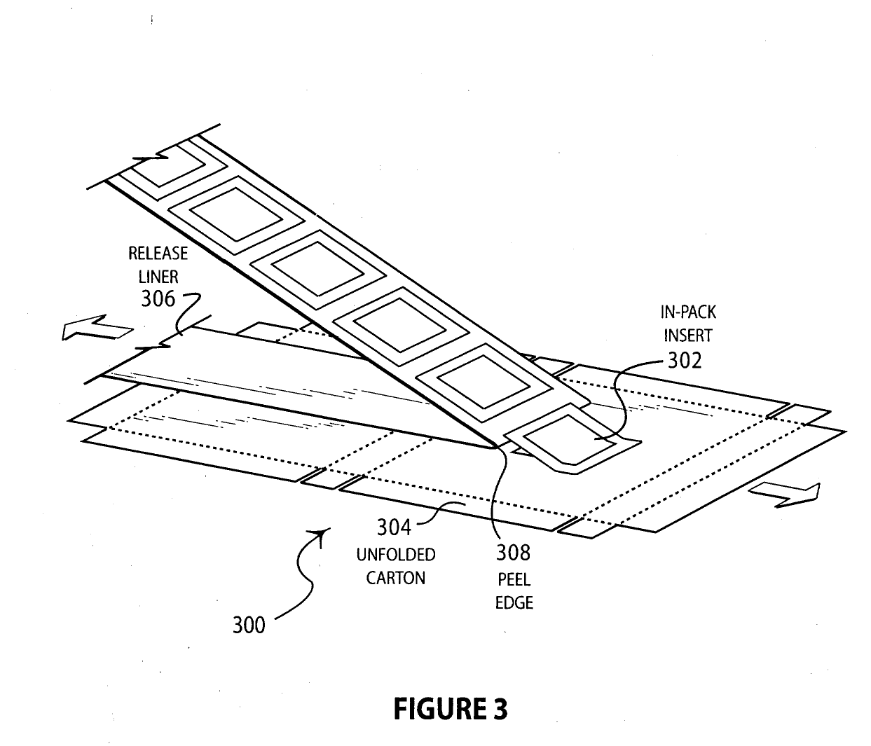

FIG. 3 illustrates an embodiment 300 of the present invention showing an in-pack item 302 that is being placed on an unfolded carton 304. The carton 304 may be presented on a conveyor line or other material handling equipment not shown. The in-pack item 302 is presented on a release liner 306. The in-pack item 302 is peeled off of the release liner 306 by the release liner 306 being pulled around a small radius peel edge 308. As the release liner 306 is advanced, the in-pack item 302 is advanced towards the carton 304.

U.S. Pat. No. 5,925,214 issued Jul. 11, 1999 to Timothy Klein and Craig Bakken (“Klein”) describes an apparatus that is suitable for the automated placement of in-pack items 302. Klein is hereby specifically incorporated herein by reference for all it discloses and teaches.

The embodiment 300 allows the repeated placement of inserts onto unfolded cartons at rates over 50,000 per hour. The speed is possible by the accuracy of presenting the inserts on a release liner 306. The method of peeling an insert off of a release liner and instantly applying the insert onto the package prohibits the insert from shifting. Further, the available technologies for controlling the placement of the insert are much more accurate than the prior art of attaching inserts with hot melt glue.

The presentation of the inserts on a release liner can be operated on a continuous basis. Fan-folded stacks of inserts may be connected to each other so that a placement machine may have a continuous supply of labels. Such a system allows an operator to periodically supply inserts to a placement machine while the machine is fully operational.

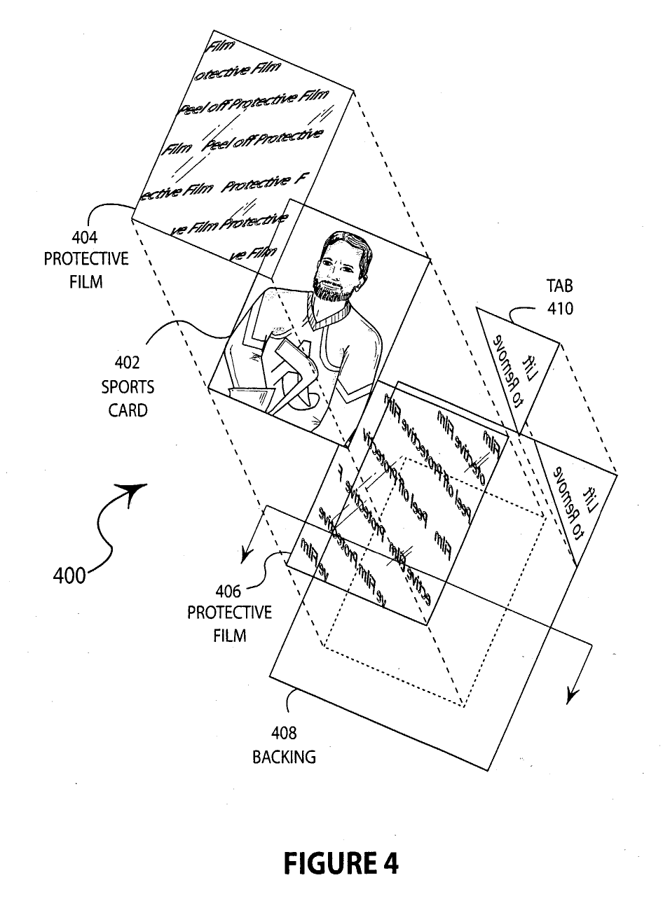

FIG. 4 illustrates an embodiment 400 of the present invention showing a collectable sports card 402 that is applied as an in-pack premium. The sports card 402 is protected with removable protective film layers 404 and 406. The sports card 402 is attached with a backing 408. The backing 408 is coated with adhesive on the surface of the backing that faces the premium. A tab 410 may be placed on the corner of the backing 408 to facilitate removal of the backing 408 by the end consumer.

The adhesive backed liner 408 is outfitted with a tab 410 for ease of removal. The tab 410 may not have adhesive present on the face that is in contact with the package, allowing the consumer to easily grasp the backing and remove the sports card 402. The adhesive backed liner 408 may be strong enough so that the consumer may remove the entire adhesive backed liner 408 with one pull. In some embodiments, the adhesive backed liner 408 may be adapted to tear in a preferential direction, such as with a notch or perforations. In other embodiments, the adhesive backed liner 408 may have a preferential direction for tearing, wherein the liner 408 may be substantially stronger in one direction than in a second.

The construction of tab 410 may be a separate piece of pre-printed material that is applied to the assembly. In another embodiment, the tab 410 may be manufactured by pre-printing or selectively applying adhesive to the liner 408. Such an embodiment may eliminate the protective film layer 406 since the liner 408 may serve the protective purpose of the protective film layer 406 while not adhering to the card 402 during removal.

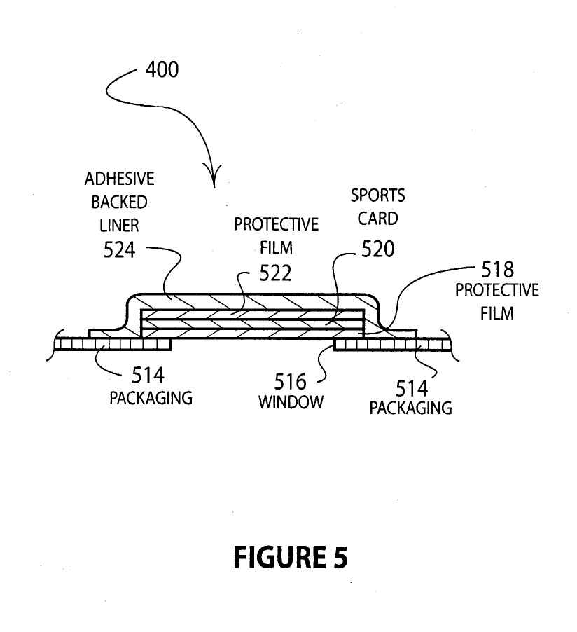

FIG. 5 is a cross sectional view of embodiment 400 of FIG. 4. The packaging 514 has a cut out window 516. The first protective film 518, sports card 520, and second protective film 522 are held in place by an adhesive backed liner 524.

The embodiment 400 allows a collectible sports card 520 to be displayed in a package for the consumer. An outside layer of protective film 518 protects the card 520 from damage due to handling of the package. An inner layer of protective film 522 protects the sports card 520 from damage when the adhesive backed liner 524 is peeled off of the assembly.

The card 520 is held inside the package 514 by having a portion of the package 514 overlap the card 520. The overlap causes the card 520 to remain securely in the package 514 and is therefore less prone to pilferage. In addition, the card 520 is set back from the outer face of the package 514 such that the card 520 is less likely to be abraded or scuffed during shipping and handling. In other embodiments, the card 520 may overlap the package 514 around the entire perimeter, in certain portions of the perimeter, or not at all.

The protective film 518 protects the surface of the card 520 from damage from the exterior of the package. The film 518 may have a very light adhesive or may be attached with static attraction such that the film 518 may be removed without damaging the surface of the card 520. The film 522 protects the card 520 from any adverse effects of the adhesive from the adhesive backed liner 524. The present embodiment 400 may be applicable to highly collectable cards or other premium or item where the pristine quality of the item is highly valued.

In an alternative embodiment, either or both of the layers of protective film 518 and 522 may be replaced by a varnish or other protective finish to the sports card 520. In some cases, an applied varnish may serve as a release agent wherein the adhesive from the adhesive backed liner 524 may not adhere or at least be readily removed.

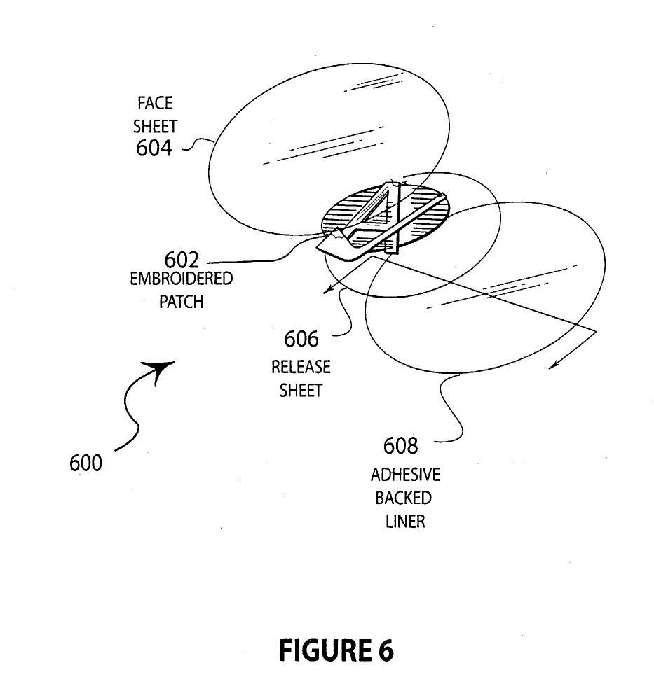

FIG. 6 illustrates an embodiment 600 of the present invention showing an embroidered patch 602 that is captured between a face sheet 604 and an optional interior release sheet 606. The patch 602 and sheets 604 and 606 are secured to the inside of a package with an adhesive backed liner 608.

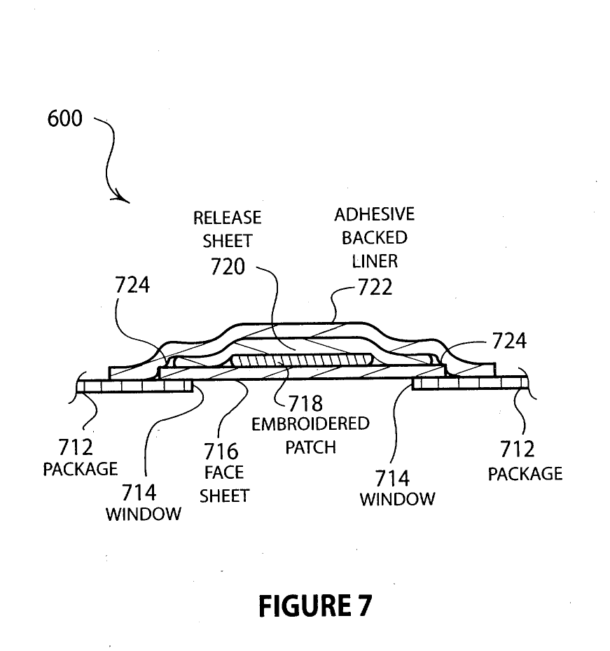

FIG. 7 illustrates a cross section view of embodiment 600 of the present invention, comprising the package 712, a window cut out 714, a face sheet 716, a patch 718, optional interior sheet 720, and adhesive backed liner 722.

The patch 602 may be an embroidered patch, a metal ornament, plastic toy, or any other non-printed object that may be desired. Other examples include screws, nuts, tools, or other assembly hardware for use with the product inside the package.

The optional interior release sheet 606 may be a preprinted backing sheet that is opaque. The sheet 606 may be present to prevent the patch 602 from becoming adhered to the adhesive of the adhesive backed liner 608.

The face sheet 604 may be selected to have a light adhesive on the interior face, that is, the face that is in contact with the patch 602. The light adhesive may be present to aid the manufacture of the embodiment 600 and keep the patch 602 from shifting in position after being placed onto the face sheet 604. The face sheet 604 may be transparent, opaque, or partially transparent. The face sheet 604 may be preprinted on the inside, outside, or both sides to highlight the patch 602.

The interior release sheet 720 may be smaller in size than the front sheet 716, allowing a portion of adhesive backed liner 722 to contact the front sheet 716 in the areas 724 and 726. In other embodiments, an adhesive on the interior side of the front sheet 716 may secure interior release sheet 720 to front sheet 716.

Adhesive backed liner 722 may be opaque. Liner 722 may be pre-printed and may thereby eliminate the need for interior release sheet 720.

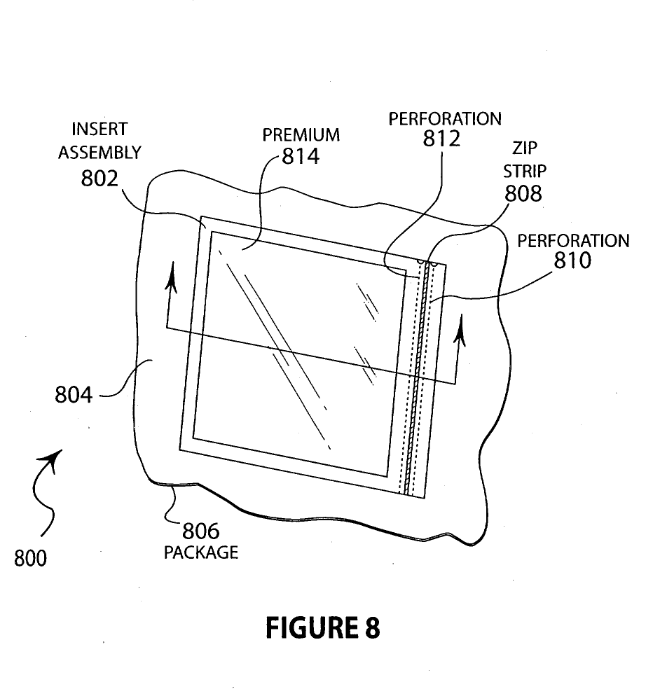

FIG. 8 illustrates an embodiment 800 of the present invention showing a zip out release mechanism that allows a consumer to easily remove a premium from a package insert. The insert assembly 802 is mounted to the inside surface 804 of a package 806. Only a portion of the package 806 is shown for clarity. An optional zip strip 808 is mounted between two lines of perforations 810 and 812. When the zip strip 808 is torn, the premium 814 may be removed by the consumer.

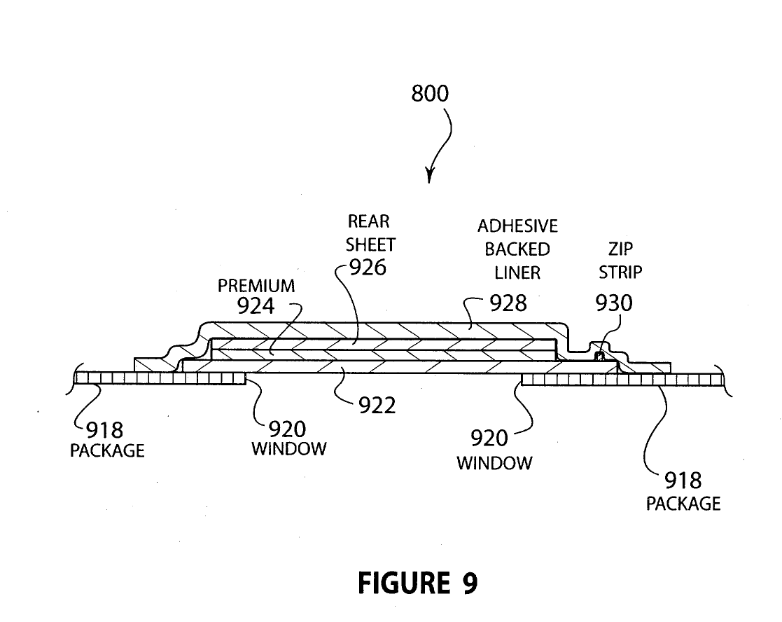

FIG. 9 is a cross sectional view of embodiment 800 of the present invention showing the package 918, a window cut out 920, a front sheet 922, the premium 924, a rear sheet 926, adhesive coated backing 928, and the zip strip 930.

The consumer may easily remove the premium 814 from the package 802 by tearing the adhesive coated backing along the perforation lines 810 and 812. The cutouts 816 and 818 may form a tab so that a consumer may grasp the zip strip 808 and pull downwards. In some embodiments, adhesive may be omitted between the perforation lines 810 and 812 to aid in removal of the zip strip. The zip strip 808 may be a string or plastic strip that increases the strength of the material between the perforation lines 810 and 812, allowing the material to be cleanly removed.

The premium 924 may be mounted between an outer sheet 922 and an inner sheet 926. The outer sheet 922 serves to protect the premium 924 from damage while the package is being handled. The outer sheet 922 may assist in guiding the premium 924 as it is slid out of the assembly.

In cases where adhesive may be selectively applied to the backing 928, the inner sheet 926 may be optionally omitted if adhesive is not present between the backing 928 and the premium 924. The inner sheet 926 may be printed with instructions facing the inside of the package 918 to instruct the consumer on the procedure for removing the premium or other printed matter.

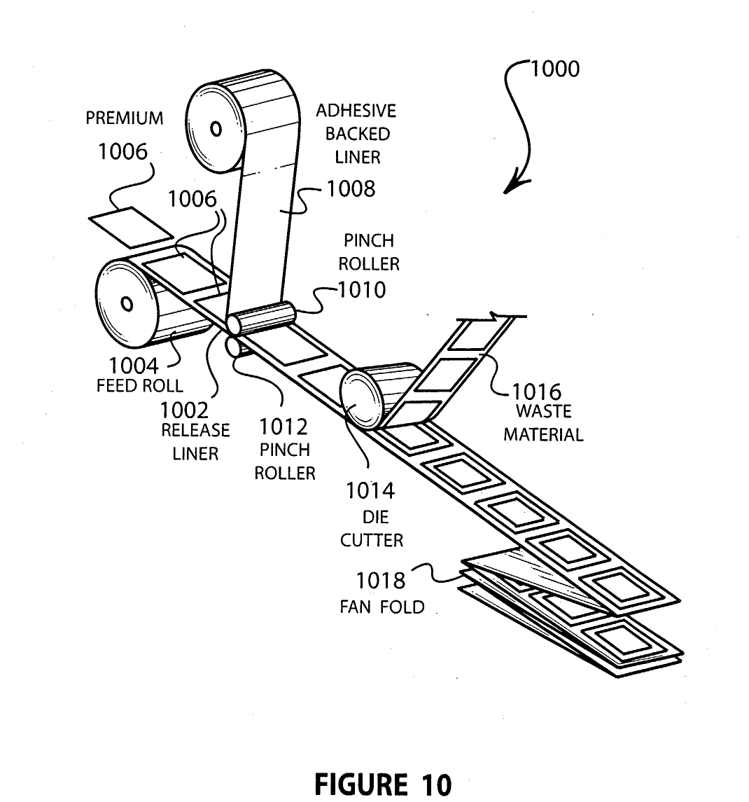

FIG. 10 illustrates an embodiment 1000 of the present invention showing a first method of producing an in-pack insert. Production of the in-pack insert proceeds from left to right in the figure. A release liner 1002 is presented on a feed roll 1004. The inserts 1006 are placed on the liner 1002 and a film 1008 with pressure sensitive adhesive is placed over the inserts 1006. Two nip rollers 1010 and 1012 press the pressure sensitive adhesive to the liner 1002 and the inserts 1006. A die cutter 1014 cuts the perimeter of the inserts 1006 and the waste material 1016 is removed. The liner 1002 is then fan folded 1018.

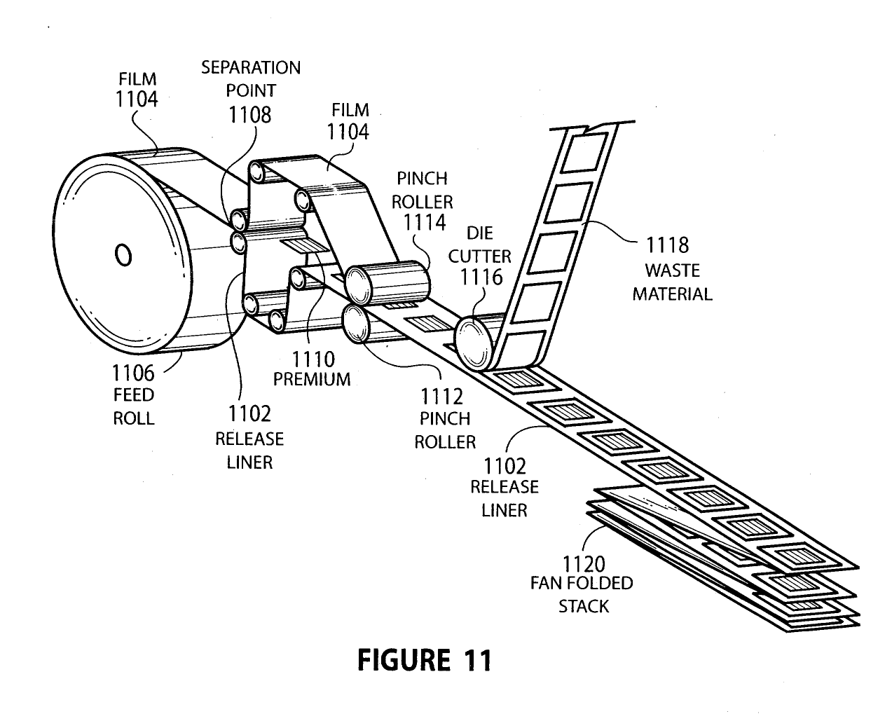

FIG. 11 illustrates an embodiment 1100 of the present invention showing a second method of producing an in-pack insert. Production of the in-pack insert proceeds from left to right in the figure. A release liner 1102 and film 1104 with pressure sensitive adhesive is supplied in a roll 1106. The release liner 1102 and film 1104 are split at a separation point 1108. An insert 1110 is placed between the liner 1102 and film 1104 and squeezed together with nip rollers 1112 and 1114. A die cutter 1116 cuts the perimeter of the adhesive film 1104 and removes the waste 1118. The liner 1102 is then fan folded 1120.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for assembling an in-pack insert to the inside of a package, said package having an inside surface, and outside surface, and a window formed therein for viewing said insert from the outside of said package comprising:
providing an insert that is substantially planar and having a viewable side and a back side;
placing said viewable side of said insert against said inside surface of said package such that at least a portion of said insert is viewable through said window;
providing a film having an adhesive side, said adhesive side having adhesive covering at least a portion of said adhesive side; and
placing said film onto said inside surface of said package such that at least a portion of said adhesive side of said film is adhered to said inside surface of said package and at least a portion of said adhesive side of said film is against said back side of said insert to hold the insert in placed on said inside surface of said package aligned with said window so that said viewable side of said insert is visible through said window on said outside of said package.

2. The method of claim 1 further comprising assembling said package.

3. A method for manufacturing an in-pack insert comprising:
providing a carrier web having a release surface;
placing an insert onto said carrier web such that a viewable portion of said insert is placed against said release surface of said carrier web;
placing an adhesive backed liner over at least a portion of said insert such that an adhesive backed side of said adhesive backed liner is placed against said release surface of said carrier web; and
presenting said carrier web such that said adhesive backed liner may be peeled from said carrier web and placed over a window in a package such that at least a portion of said viewable surface of said insert is viewable through a window of said package when viewed from an external surface of said package.

4. The method of claim 3 further comprising partially coating said adhesive backed side of said adhesive backed liner with adhesive.

5. The method of claim 3 further comprising partially coating said adhesive backed side of said adhesive backed liner with pressure sensitive adhesive.

6. The method of claim 3 wherein said insert is substantially planar.

7. The method of claim 3 further comprising placing a release film between said insert and said adhesive backed liner.

8. The method of claim 3 further comprising weakening at least a portion of said adhesive backed liner whereby a consumer may remove said insert from said package.

9. The method of claim 8 wherein said weakening comprises providing a tab.

10. The method of claim 8 further comprises placing a zip strip in contact with said adhesive backed liner in the proximity of said portion of said adhesive backed liner that is weakened.

11. The method of claim 3 further comprising placing a face sheet onto said carrier web between said carrier web and said insert, said face sheet being at least partially transparent.

12. The method of claim 3 further comprising placing a removal tab against said adhesive backed side of said adhesive backed liner such that said removal tab is adapted to assist a consumer in removing said insert from said package.

13. The method of claim 3 further comprising:
die cutting at least said adhesive backed liner such that said carrier web remains in tact; and
removing any excess adhesive backed liner from said carrier web.

14. A package with an in-pack insert comprising:
a package having a window, an outside surface, and an inside surface, said outside surface being a viewable surface when said package is assembled;
an insert being substantially planar and having a viewable side and a back side, said viewable side of said insert being placed against said inside surface of said package such that at least a portion of said insert is viewable through said window;
a film having an adhesive side, said adhesive side having adhesive covering at least a portion of said adhesive side, said film being placed onto said inside surface of said package such that at least a portion of said adhesive side of said film is against said inside surface of said package and at least a portion of said adhesive side of said film is against said back side of said insert.

15. An in-pack insert comprising:
a carrier web having a release surface;
an insert placed onto said carrier web such that a viewable portion of said insert is placed against said release surface of said carrier web;
an adhesive backed liner placed over at least a portion of said insert such that an adhesive backed side of said adhesive backed liner is placed against said release surface of said carrier web, such that said adhesive backed liner may be peeled from said carrier web and placed over a window in a package such that at least a portion of said viewable surface of said insert is viewable through said window of said package when viewed from an external surface of said package.

16. The in-pack insert of claim 15 further comprising said adhesive backed side of said adhesive backed liner being partially coated with adhesive.

17. The in-pack insert of claim 15 further comprising said adhesive backed side of said adhesive backed liner being at least partially coated with pressure sensitive adhesive.

18. The in-pack insert of claim 15 wherein said insert is substantially planar.

19. The in-pack insert of claim 15 further comprising a release film between said insert and said adhesive backed liner.

20. The in-pack insert of claim 15 further comprising a weakened portion of said adhesive backed liner whereby a consumer may remove said insert from said package.

21. The in-pack insert of claim 20 further comprising a tab portion of said adhesive backed liner.

22. The in-pack insert of claim 20 further comprising a zip strip placed in contact with said adhesive backed liner in the proximity of said portion of said adhesive backed liner that is weakened.

23. The in-pack insert of claim 15 further comprising a face sheet placed onto said carrier web between said carrier web and said insert, said face sheet being at least partially transparent.

24. The in-pack insert of claim 15 further comprising a removal tab placed against said adhesive backed side of said adhesive backed liner such that said removal tab is adapted to assist a consumer in removing said insert from said package.

25. An in-pack insert comprising:
a first means for visually enhancing a package;
a second means for releasably carrying and presenting said first means; and
a third means for entrapping said first means to an inside surface of said package such that said second means is viewable through a window in said package.

26. The in-pack insert of claim 25 wherein said third means comprises a pressure sensitive adhesive.

27. The in-pack insert of claim 26 wherein said third means comprises a plurality of laminates.

28. The in-pack insert of claim 27 wherein said third means comprises a means for enabling a consumer to remove said first means from said package.
